(19) United States
(12) Patent Application Publication
(10) Pub. No.: US 2025/0131534 A1
(43) Pub. Date: Apr. 24, 2025

(54) Electronic Device with Centrally Located Under-Display Image Sensor

(71) Applicant: Google LLC, Mountain View, CA (US)

(72) Inventors: Changgeng Liu, San Jose, CA (US); Marek Mienko, San Jose, CA (US); Hart Levy, Redwood City, CA (US); Ion Bita, Los Altos, CA (US); Xi Chen, Mountain View, CA (US)

(73) Assignee: Google LLC, Mountain View, CA (US)

(21) Appl. No.: 18/999,529

(22) Filed: Dec. 23, 2024

Related U.S. Application Data
(60) Provisional application No. 63/735,538, filed on Dec. 18, 2024.

(51) Int. Cl. G06T 5/50; G06T 5/20; G06T 5/60; G06T 7/70; H04N 23/56; H04N 23/90; H04N 23/95; H04N 25/40; H04N 25/532

(52) U.S. Cl. CPC G06T 5/50; G06T 5/20; G06T 5/60; G06T 7/70; H04N 23/56; H04N 23/90; H04N 23/95; H04N 25/41; H04N 25/532; G06T 2207/20081; G06T 2207/20221

(57) ABSTRACT

Systems and techniques directed at an electronic device with a centrally located under-display image sensor are disclosed. The electronic device includes a first image sensor and a second image sensor, the second image sensor being an under-display sensor located at substantially a center of a display of the electronic device. The first image sensor may be located adjacent to an edge of the display. The second image sensor is configured to capture an eye gaze of a user and provide the captured eye gaze to correct the eye gaze of images captured by the first image sensor. The first image sensor may also be an under-display image sensor. During video communications with the electronic device, a user usually looks at the center of the display of the electronic device. The second image sensor is configured to capture the correct eye gaze of the user during video communications.

### CROSS-REFERENCE TO RELATED APPLICATION(S)

This application claims the benefit of U.S. Provisional Patent Application Ser. No. 63/735,538 filed on Dec. 18, 2024, the disclosure of which is incorporated by reference herein in its entirety.

### SUMMARY

This document describes systems and techniques directed at an electronic device with a centrally located under-display image sensor. The electronic device includes a first image sensor and a second image sensor, the second image sensor being the under-display sensor, which is located at substantially the center of a display of the electronic device. The second image sensor is configured to capture the eye gaze of the user and provide the captured eye gaze to correct the eye gaze of images captured by the first image sensor, which is located adjacent to an edge of the display. Typically, the first image sensor is located adjacent to an upper edge of the electronic device and may be positioned above an upper edge of the display. During video communications with the electronic device, a user usually looks at the center of the display of the electronic device. The second image sensor is configured to capture the eye gaze of the user during video communications. In other words, the second image sensor is positioned under the display at approximately the center of the display screen.

In one implementation, the techniques described herein relate to an apparatus that comprises an electronic device. The electronic device includes an emissive display having a plurality of pixels. The electronic device includes a first image sensor located adjacent to an edge of the emissive display. The electronic device includes a second image sensor. The second image sensor is an under-display sensor located substantially at a center of the emissive display. The second image sensor is configured to capture an eye gaze of a user and provide the captured eye gaze to the first image sensor.

The details of one or more implementations are set forth in the accompanying Drawings and the following Detailed Description. Other features and advantages will be apparent from the Detailed Description, the Drawings, and the Claims. This Summary is provided to introduce subject matter that is further described in the Detailed Description. Accordingly, a reader should not consider the Summary to describe essential features or limit the scope of the claimed subject matter.

### BRIEF DESCRIPTION OF DRAWINGS

Apparatuses of and techniques for an electronic device with a centrally located under-display image sensor are described with reference to the following drawings. The same numbers are used throughout the drawings to reference like features and components.

FIG. 1 illustrates an example electronic device having a display with a first image sensor and a second image sensor, the second image sensor being an under-display sensor located at substantially a center of the display.

FIG. 2 illustrates a second image sensor of an electronic device that is configured to capture an eye gaze of a user.

FIG. 3 illustrates a partial cross-sectional view of an electronic device that includes an under-display image sensor located at approximately a center of a display.

FIG. 4 illustrates a partial cross-sectional view of a display for an electronic device.

FIG. 5 is a schematic that illustrates timing signals for capturing an image with an under-display image sensor and for activating a display.

FIG. 6 is a flow chart that illustrates a process of correcting images with a user's eye gaze captured by an under-display image sensor located at substantially a center of a display of an electronic device.

### DETAILED DESCRIPTION

### Overview

Various electronic devices such as mobile phones and tables include one or more image sensors (e.g., cameras) to enable the electronic device to capture images. The image sensors are used for video communications. Image sensor(s) located on a front side of the electronic device are usually located near a top edge of the electronic device. The image sensor(s) may be located above a top edge of a display of the electronic device or may be located at an upper end of the display. The display may be an emissive display. A user typically looks at the center of the display of the electronic device during video communications rather than looking directly at the image sensor(s). The gaze of the user towards the center of the display causes the image sensor(s) to not capture the correct eye gaze of the user during video communications.

To this end, this document describes systems and techniques directed at an electronic device with a centrally located under-display image sensor. The under-display image sensor captures a correct eye gaze of a user looking at the center of the display. The captured correct eye gaze may then be used to correct an eye gaze captured from an image sensor located at an edge of the electronic device. The under-display image sensor may be a grayscale camera and the other image sensor(s) located adjacent to the edge of the electronic device may be a red-green-blue camera. The under-display image sensor can be a grayscale camera because the under-display image sensor does not provide an entire image for video communications. Instead, the image captured by the under-display image sensor located at approximately the center of the display may be used to correct the eye gaze of the images captured by the other image sensor(s) of the electronic device primarily used for video communications. The under-display image sensor may be positioned beneath a substantially transparent portion of the display.

The following discussion describes techniques that may be employed in the example operating apparatuses and environments. Although systems and techniques for an electronic device with a centrally located under-display image sensor are described, it is to be understood that the subject of the appended Claims is not necessarily limited to the specific features or methods described. Rather, the specific features are disclosed as example implementations and reference is made to the operating environment by way of example only.

### Example Apparatuses and Systems

An electronic device includes an under-display image sensor located at a center of an emissive display of the electronic device used to correct, or modify, a user's eye gaze captured by other image sensor(s) located adjacent to an edge of the electronic device. Deconvolution-based image filtering may be used to enhance the eye gaze captured by the under-display image sensor. In other aspects, a machine-learned model may enhance the eye gaze captured by the other image sensor(s) based on the eye gaze captured by the under-display image sensor. The machine-learned model may be configured to fuse an image captured by the under-display image sensor with an image captured by the other image sensor(s). The under-display image sensor may be coupled with a global shutter configured to prevent the capture of light from the emissive display. A portion of the emissive display may be substantially transparent at approximately the center of the emissive display. The under-display image sensor may be positioned below the substantially transparent portion of the emissive display. The electronic device may be configured to include a pulse width modulation signal configured to trigger image acquisition of the under-display image sensor when pixels located above the under-display image sensor are off.

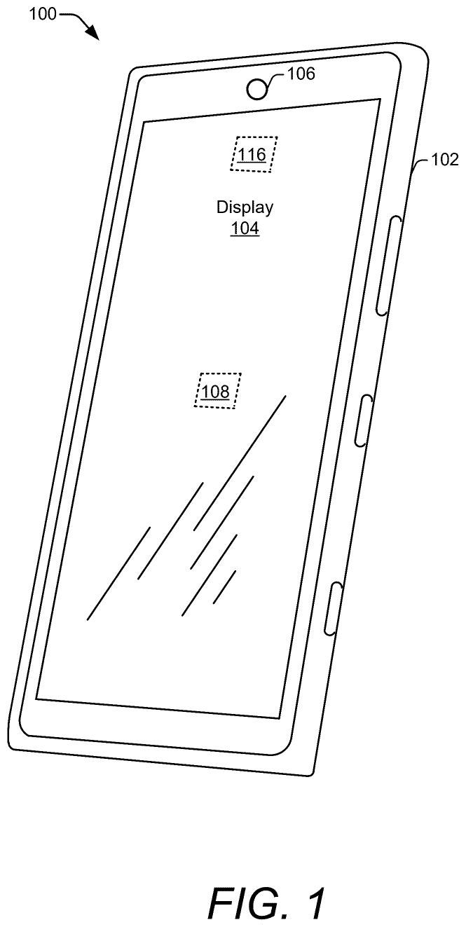

FIG. 1 illustrates an apparatus 100 that includes an electronic device 102 with a display 104, a first image sensor 106, and a second image sensor 108 that is an under-display image sensor. The display 104 may be an emissive display, and the first image sensor 106 is located above an upper edge of the display 104. The first image sensor 106 may be a red-green-blue camera that is a primary camera for video communications using the electronic device 102. The electronic device 102 may include more than one image sensor 106 located adjacent to an edge of the electronic device 102 as would be appreciated by one of ordinary skill in the art having the benefit of this disclosure.

The second image sensor 108 is located approximate to a center of the display 104. As used herein, located approximate to the center of the display 104 means the second image sensor 108 is located closer to the center of the display 104 than to an edge of the display 104. For example, the second image sensor 108 is located between the center of the display 104 and a midpoint between the actual center of the display 104 and an edge of the display 104. The second image sensor 108 is configured to capture an eye gaze of a user that looks toward the center of the display 104. The captured eye gaze from the second image sensor 108 may be provided to the first image sensor 106. The first image sensor 106 may use the eye gaze captured by the second image sensor 108 to correct a user's eye gaze captured by the first image sensor 106. A machine-learned model may be trained to enhance the eye gaze of the user captured by the first image sensor 106 with the eye gaze captured by the second image sensor 108. In some aspects, the machine-learned model may fuse the eye gaze captured by the second image sensor 108 with the image captured by the first image sensor 106.

The first image sensor 106 may be a red-green-blue camera and may have a first pixel size and a first lens aperture size. The second image sensor 108 may be a grayscale camera because the second image sensor 108 is used to capture the eye gaze and is not the primary camera to provide images during video communications. The second image sensor 108 may have a second pixel size and a second lens aperture size. The second pixel size and the second aperture size may be larger than the first pixel size and the first aperture size. In other aspects, the second image sensor 108 may have a smaller pixel count than a pixel count of the first image sensor 106 and the second image sensor 108 may operate at a lower power level than the power level the first image sensor 106 operates at.

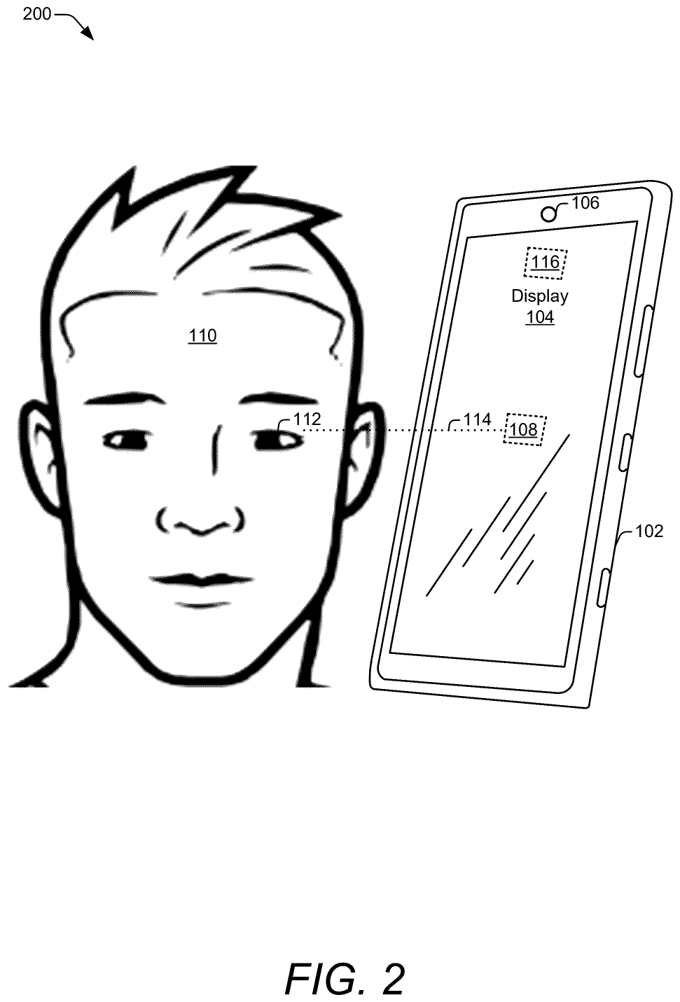

The electronic device 102 may include one or more processors 116. The one or more processor 116 may be a processor on a system-on-chip (Soc). For example, the processor 116 may be a central processing unit, a graphics processing unit, an image signal processor, video processor, or other processing component configured to handle different image and/or video processing requirements. In one aspect, the one or more processors 116 may include an image processor physically packaged with the first image sensor 106. The one or more processors 116 may be configured for gaze extraction of a captured eye gaze as discussed herein. The one or more processors 116 may be configured to fuse captured images as discussed herein. FIG. 2 illustrates that the second image sensor 108 is an under-display image sensor configured to capture an eye gaze of a user.

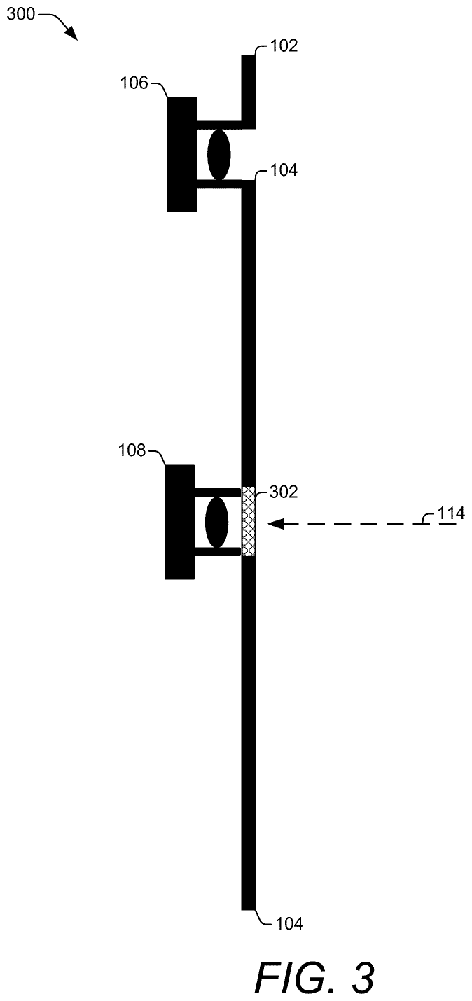

FIG. 2 illustrates an environment 200 of a user 110 utilizing the electronic device 102 for video communications. The second image sensor 108 is located beneath the emissive display 104 of the electronic device 102. The second image sensor 108 is located at substantially the center of the emissive display 104 and, thus, is configured to capture a correct eye gaze (indicated by a dotted line 114) from the eyes 112 of the user 110. The eye gaze 114 captured by the second image sensor 108 may be used to modify the eye gaze of images of the user 110 captured by the first image sensor 106. The one or more processors 116 of the electronic device 102 may be configured to modify the eye gaze of images of the user 110 captured by the first image sensor 106 with the eye gaze 114 captured by the second image sensor 108. The second image sensor 108 may be positioned beneath a substantially transparent portion of the emissive display 104 as shown in FIG. 3.

FIG. 3 illustrates an aspect of an apparatus of an electronic device 102 and shows a partial cross-sectional view of the electronic device 102. The electronic device 102 includes an emissive display 104. For clarity, FIG. 3 shows the first image sensor 106, the second image sensor 108, and the display 104 and omits other aspects of the electronic device 102. The first image sensor 106 is located at an upper end of the electronic device 102. The first image sensor 106 may be positioned above an upper edge of the emissive display 104. Alternatively, the first image sensor 106 could be positioned adjacent to an aperture in the display 104.

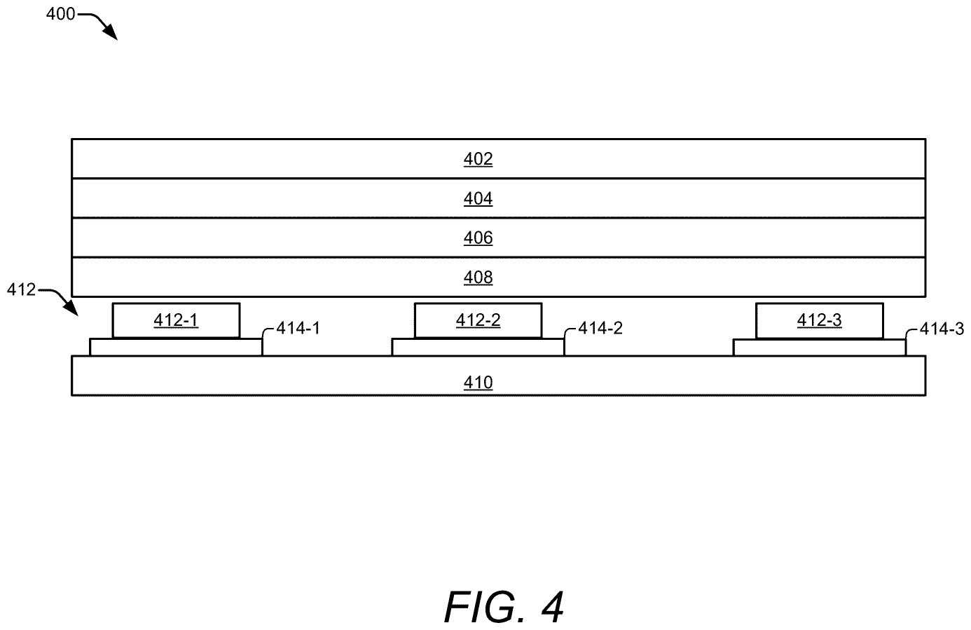

The second image sensor 108 is an under-display image sensor located at approximately a center of the emissive display 104. A global shutter may be coupled with the second image sensor 108. The global shutter may be configured to prevent the capture of light from the emissive display 104. A global shutter enables the second image sensor 108 to capture an entire image all at once. In comparison, a rolling shutter exposes an image sensor from top to bottom. A portion 302 of the emissive display 104 is configured to be substantially transparent to enable the second image sensor 108 to capture the eye gaze 114 of a user that looks toward the center of the emissive display 104. One aspect of a substantially transparent display is shown in FIG. 4.

FIG. 4 illustrates a transparent portion 400 of an emissive display 104. The transparent portion 400 includes a hard coat layer 402, a glass layer 404, a polarizer layer 406, an encapsulation layer 408, and a support layer 410. An organic light emitting diode (OLED) layer 412 is positioned between the encapsulation layer 408 and the support layer 410. The OLED layer 412 includes a plurality of OLEDs positioned on metal support layers. For example, the OLED layer 412 includes a red OLED 412-1 positioned on a first metal support layer 414-1, a green OLED 412-2 positioned on a second metal support layer 414-2, and a blue OLED 412-3 positioned on a third metal support layer 414-3. The numbers of OLEDs (e.g., red OLED 412-1, green OLED 412-2, blue OLED 412-3) and metal support layers (e.g., first, second, and third metal support layers 414-1, 414-2, and 414-3) are shown for illustrative purposes and may be varied as would be appreciated by one of ordinary skill in the art having the benefit of this disclosure.

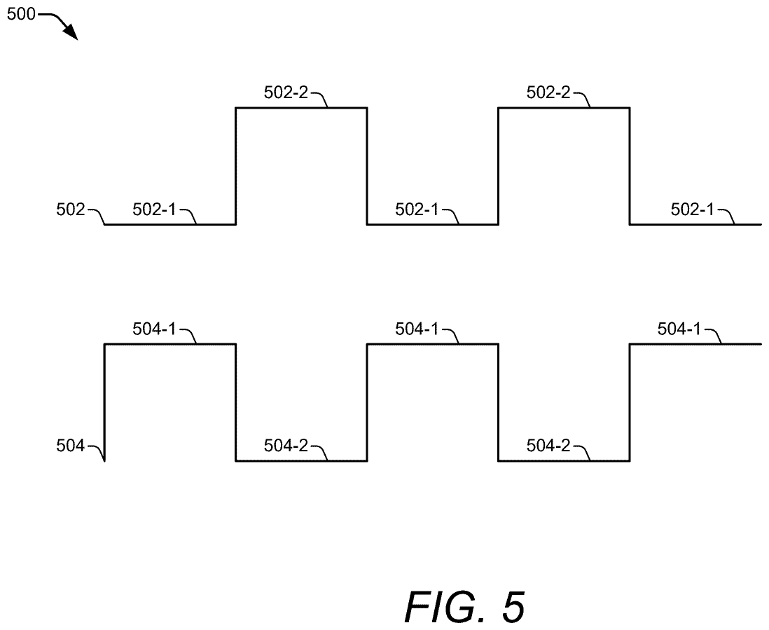

In some aspects, the transparent portion 400 of the emissive display 104 may be formed by relocating drive circuitry for the OLEDs (e.g., red OLED 412-1, green OLED 412-2, blue OLED 412-3) of the OLED layer 412 outside of a boundary of the transparent portion 400 as would be appreciated by one of ordinary skill in the art having the benefit of this disclosure. In other words, the drive circuitry to operating the OLEDs beneath the transparent portion 400 of the emissive display 104 are located outside the boundary of the transparent portion 400. The relocation of the drive circuitry enables the portion 400 of the emissive display 104 to be substantially transparent. A second image sensor 108, which is an under-display image sensor, may be located underneath the substantially transparent portion 400 of the display 104 to enable the second image sensor 108 to capture an eye gaze 114 from a user 110. The substantially transparent portion 400 of the display 104 and a global shutter are configured to prevent the second image sensor 108 from capturing light from the emissive display 104. FIG. 4 illustrates one example display of an OLED display having a polarizer layer 406 that includes a transparent portion 400. However, other types of displays may include a transparent portion 400 as would be appreciated by one of ordinary skill in the art. For example, a display having a transparent portion 400 may be a liquid crystal display, an encapsulation OLED that includes a color filter, or the like. FIG. 5 also shows a pulse modulation signal configured to prevent the second image sensor 108 from capturing light from the emissive display 104.

FIG. 5 illustrates a schematic 500 of timing signals for capturing an image with an under-display image sensor and for activating the display 104. The schematic 500 includes a first signal 502 for the capture of images by the second image sensor 106 and a second signal 504 for the operation of the emissive display 104. The first signal 502 is pulse width modulated with respect to the second signal 504. In other words, the first signal 502 is “off” during the time period that the second signal 504 is “on”. Likewise, the first signal 502 is “on” during the time period that the second signal 504 is “off”. The pulse width modulated first signal 502 causes the second image sensor 106 to capture an image while the portion of the emissive display 104 above the second image sensor 106 is off.

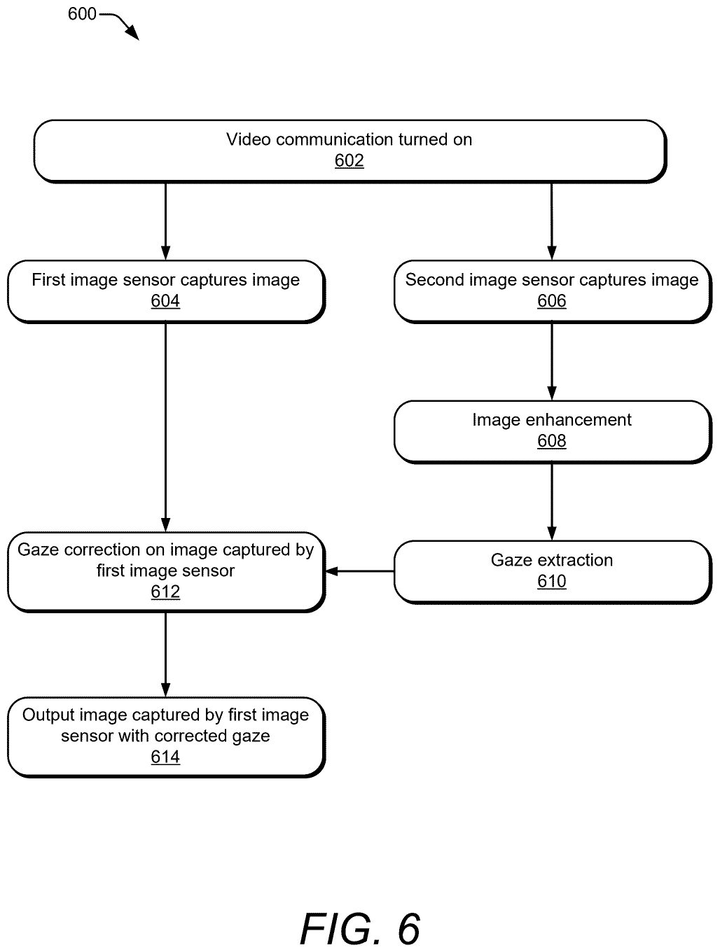

The first signal 502 includes low (e.g., “off”) signals 502-1 during which the second image sensor 108 does not capture images and high (e.g., “on”) signals 502-2 during which the second image sensor 108 captures images. The second signal 504 includes high (e.g., “on”) signals 504-1 during which the emissive display 104 is turned on and low (e.g., “off”) signals 504-2 during which the emissive display 104 is turned off. The low signals 502-1 of the first signal 502 correspond to the timing of the high signals 504-1 of the second signal 504. Likewise, the high signals 502-2 of the first signal 502 correspond to the timing of the low signals 504-2 of the second signal 504. The use of a pulse width modulated signal 502 to capture images with the second image sensor 108 with respect to the signal 504 to turn on and off the emissive display 104 is configured to ensure that the second image sensor 108 does not inadvertently capture light from the emissive display 104. The eye gaze captured by the second image sensor 108 may be used to correct the eye gaze of images captured by the first image sensor 106 as discussed regarding FIG. 6.

FIG. 6 illustrates a process 600 of correcting images with a user's eye gaze captured by an under-display image sensor located at substantially a center of a display of an electronic device. The method is shown as a set of blocks that specify operations performed but are not necessarily limited to the order or combinations shown for performing the operations by the respective blocks. Further, any one or more of the operations can be repeated, combined, reorganized, or linked to provide a wide array of additional and/or alternate methods. In portions of the following discussion, reference can be made to the example apparatus of FIG. 1 or to entities or processes as detailed in FIGS. 2-5, reference to which is made for example only.

At 602, video communication is turned on. For example, a user 110 may utilize an electronic device 102 for video communication.

At 604, a first image sensor captures an image. For example, a first image sensor 106 that is located at an edge of the electronic device 102 may capture an image of the user 110 for use in video communications.

At 606, a second image sensor captures an image. For example, an under-display second image sensor 108 located at substantially a center of an emissive display 104 of the electronic device 102 may capture an image of an eye gaze 114 of a user 110 that looks toward the center of the emissive display 104.

At 608, the image captured by the second image sensor is enhanced. For example, a machine-learned model may enhance the image captured by the second image sensor 108 located under the emissive display 104.

At 610, an eye gaze of a user is extracted. For example, one or more processors 116 may extract the eye gaze 114 captured by the second image sensor 108 to then be used to modify the eye gaze captured by the first image sensor 106, e.g., using the machine-learned model.

At 612, the gaze is corrected on the image captured by the first image sensor. For example, one or more processors 116 may correct the eye gaze of the user 110 on the image captured by the first image sensor 106 based on the eye gaze 114 from the image captured by the second image sensor 108. In an implementation, one or more processors 116 may be configured to fuse the image captured by the first image sensor 106 with the eye gaze 114 from the image captured by the second image sensor 108, e.g., using the machine-learned model.

At 614, the image captured by the first image sensor with corrected gaze is output. For example, the image captured by the first image sensor 106 may be displayed on the emissive display 104 with the eye gaze corrected from the image captured by the second image sensor 108.

For the methods described herein and the associated flow chart(s) and flow diagram(s), the orders in which operations are shown and/or described are not intended to be construed as a limitation. Instead, any number or combination of the described method operations can be combined in any order to implement a given method or an alternative method, including by combining operations from the flow chart or diagram and the earlier-described schemes and techniques into one or more methods. Operations may also be omitted from or added to the described methods. Further, described operations can be implemented in fully or partially overlapping manners.

### Conclusion

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

Terms such as “above,” “below,” or “underneath” are not intended to require any particular orientation of a device. Rather, a first layer or component being provided “above” a second layer or component is intended to describe the first layer being at a higher Z-dimension than the second layer or component within the particular coordinate system in use. It will be understood that should the component be provided in another orientation, or described in a different coordinate system, then such relative terms may be changed.

Although implementations for an electronic device with a centrally located under-display image sensor have been described in language specific to certain features and/or methods, the subject of the appended claims is not necessarily limited to the specific features or methods described. Rather, the specific features and methods are disclosed as example implementations for an electronic device with a centrally located under-display image sensor.

What is claimed is:

1. An apparatus comprising:
an electronic device, the electronic device comprising:
an emissive display comprising a plurality of pixels;
a first image sensor, the first image sensor located adjacent to an edge of the emissive display; and
a second image sensor, the second image sensor being an under-display sensor located substantially at a center of the emissive display, the second image sensor configured to capture an eye gaze of a user; and
at least one image processor, receiving the image from the first image sensor and second image sensor.

2. The apparatus of claim 1, further comprising:
the least one processor configured to modify the eye gaze captured by the first image sensor using the captured eye gaze received from the second image sensor.

3. The apparatus of claim 2, wherein a portion of the emissive display adjacent to the second image sensor is substantially transparent.

4. The apparatus of claim 3, wherein the second image sensor comprises a grayscale camera.

5. The apparatus of claim 4, wherein the first image sensor comprises a red-green-blue camera.

6. The apparatus of claim 4, further comprising:
a global shutter coupled with the second image sensor, the global shutter configured to prevent a capture of light from the emissive display.

7. The apparatus of claim 4, wherein drive circuitry for subpixels adjacent to the portion is located outside of a boundary of the substantially transparent portion.

8. The apparatus of claim 4, wherein the first image sensor comprises a first pixel size and a first lens aperture size and the second image sensor comprises a second pixel size and second lens aperture size, the second pixel size and the second lens aperture size being larger than the first pixel size and the first lens aperture size.

9. The apparatus of claim 4, wherein the first image sensor has a first pixel count and the second image sensor has second pixel count, the second pixel count being smaller than the first pixel count.

10. The apparatus of claim 9, wherein the first image sensor operates at a first power level and the second image sensor operates at a second power level, the second power level being lower than the first power level.

11. The apparatus of claim 4, wherein deconvolution-based image filtering enhances the eye gaze of the user captured by the second image sensor.

12. The apparatus of claim 4, further comprising a machine-learned model, wherein the machine-learned model enhances the eye gaze of the user captured by the second image sensor.

13. The apparatus of claim 12, wherein the machine-learned model is configured to fuse the image captured with the first image sensor with the eye gaze captured with the second image sensor.

14. The apparatus of claim 4, wherein the second image sensor is configured to capture an image when pixels, of the plurality of pixels, located above the second image sensor are off.

15. The apparatus of claim 1, wherein the at least one processor includes an image processor physically packaged with the first image sensor.
